(19) United States
(12) Patent Application Publication
(10) Pub. No.: US 2024/0146416 A1
(43) Pub. Date: May 2, 2024

(54) METHOD AND APPARATUS FOR ENHANCEMENT OF COMMON MODE REJECTION ON COHERENT OPTIC RECEIVERS

(71) Applicants: Conor O'Keeffe, Cork (IE); Anthony Kelly, Limerick (IE); Adam Herrmann, Dublin (IE); Finbarr O'Regan, Innishannon (IE); Sundar Krishnamurthy, Dublin, CA (US); Amy Whitcombe, Saratoga, CA (US); Ricard Menchon Enrich, Dublin (IE); Deepak Dasalukunte, Beaverton, OR (US)

(72) Inventors: Conor O'Keeffe, Cork (IE); Anthony Kelly, Limerick (IE); Adam Herrmann, Dublin (IE); Finbarr O'Regan, Innishannon (IE); Sundar Krishnamurthy, Dublin, CA (US); Amy Whitcombe, Saratoga, CA (US); Ricard Menchon Enrich, Dublin (IE); Deepak Dasalukunte, Beaverton, OR (US)

(21) Appl. No.: 17/979,234

(22) Filed: Nov. 2, 2022

(51) Int. Cl. H04B 10/40; H04B 10/112

(52) U.S. Cl. CPC H04B 10/40; H04B 10/112

(57) ABSTRACT

A method for calibrating an optical transceiver. The method can include configuring optical switches to enable routing at least one output signal of modulator circuitry operably coupled to a first receive path of a coherent optical transceiver. The method can include configuring the input to at least one modulator to generate at least one first stimulus signal. The method can include configuring a path from the first receiver analog-to-digital converter to an adaptive algorithm circuitry. The method can include adapting at least one bias setting of a photodiode associated with the first receiver in response to at least one first stimulus detected at the first receiver analog-to-digital converter to an adaptive algorithm circuitry. The method can include determining an optimum value of a photodiode associated with the first receiver.

### STATEMENT OF GOVERNMENT INTEREST

This invention was made with government support under Agreement HR00112290040-0106 awarded by Defense Advanced Research Projects Agency (DARPA). The government has certain rights in the invention.

### TECHNICAL FIELD

Embodiments pertain to optical communications, and more specifically to coherent optical receivers.

### BACKGROUND

Coherent optical transceivers have been used for high bandwidth long haul optical fiber links in trans-ocean fiber connections and are now finding use in other applications due to improved reach and capacity relative to other schemes. Coherent receiver detection is performed by “mixing” a Local Oscillator (LO) Laser with the incoming received signal. The LO laser in most receiver architectures is substantially the same frequency or wavelength as that used by the transmitter. Unlike radio frequency (RF) systems of similar architecture where carrier frequencies and LO sources are referenced off an accurate clock source, laser sources are much less accurate to control. Coherent optical receivers are susceptible to impact from common mode interference hence the widespread adoption of a double balanced photodiode configuration for coherent detection. Mismatch on the photodiode responsivity used in the receiver can give rise to degrading the common-mode-rejection performance generating an interference to the receiver. There is a general need to improve receiver performance and minimize the impact of such interference.

### BRIEF DESCRIPTION OF THE DRAWINGS

FIG. 1 illustrates an exemplary functional block diagram of coherent optical transceiver circuitry in accordance with some aspects.

FIG. 2 is a block diagram of a communication system that can include satellite communication systems in accordance with some aspects.

FIG. 3 illustrates a schematic diagram of an apparatus in which methods according to aspects can be implemented.

FIG. 4 illustrates feedback paths in the context of photonic sections of a coherent transceiver in accordance with some aspects.

FIG. 5 illustrates DAC bias control according to one aspect.

FIG. 6 illustrates DAC bias control according to another aspect.

FIG. 7 illustrates a calibration method according to some aspects.

### DETAILED DESCRIPTION

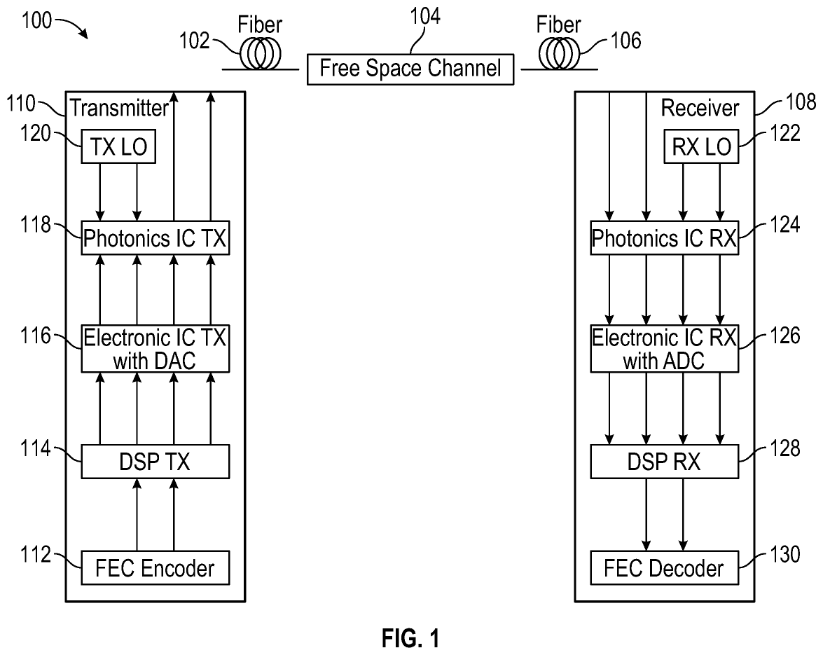

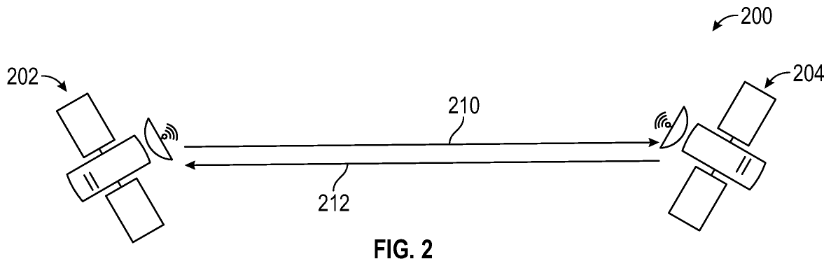

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims. Systems in which methods and algorithms can be implemented are discussed with reference to FIG. 1-FIG. 2.

FIG. 1 illustrates a functional block diagram of a coherent optical transceiver circuitry 100 in accordance with some aspects. The coherent optical transceiver circuitry 100 includes a transmit fiber 102 connecting the transmitter modem to an optical aperture, which transmits an optical signal over a free space channel 104 (e.g., in a channel medium or channel media), and a receiver fiber 106 forwards the signal from a receiver optical aperture to the receiver circuitry 108. A transmitter 110 includes a Forward Error Correction (FEC) encoder 112 to encode a bit stream, digital signal processing (DSP) circuitry 114 to frame, modulate and generate the transmit waveform, transmitter electronics (EIC) circuitry 116 to convert a digital signal to an analog signal, transmitter photonics (PIC) circuitry 118 to convert the electrical signal to optical signal, and laser source circuitry 120 to generate an optical signal. Receiver circuitry 108 includes laser source 122 to coherently combine the received optical signal, receiver photonics circuitry (PIC) 124 to convert a received optical signal to an electrical signal, receiver electronics circuitry (EIC) 126 to convert an analog signal to a digital signal, digital signal processing circuitry 128 to correct impairments and demodulate the bits and a FEC decoder circuitry 130 to decode a bit stream. Within a modem, the integrated circuit 116 and integrated circuit 126 can be the same circuit. In some embodiments functions 126, 128, 130, 116, 114 and 112 functions can be integrated on the same package or monolithically.

Coherent optical transceivers have been used for high bandwidth long haul optical fiber links for some time such as in trans-ocean fiber connections. In recent times coherent transceivers are becoming more prevalent on other applications owing to the longer reach and better data-carrying capacity over legacy OOK (On-off key) based intensity modulation/demodulation schemes. Coherent detection techniques can be used on fiber as well as FSO (free-space optics) propagation channel mediums, for example in terrestrial or satellite-to-satellite systems, or terrestrial-to-satellite systemsCoherent can be used to recover OOK modulation with better link budget, however the vast majority of OOK deployments has relied on a direct intensity demodulation owing to the low complexity of the receiver.

For example, coherent optical transceivers can be used in inter-satellite links (ISLs) used in systems similar to FIG. 2. FIG. 2 is a block diagram of a communication system 200 that can include satellite communication systems in accordance with some aspects. The system 200 can include two or more satellites 202, 204. While two satellites 202, 204 are shown, the communication system 200 can include any number of satellites or other communications devices. The satellites 202, 204 can be located, for example, at a geostationary or non-geostationary orbital location. Where a satellite 202, 204 is in a non-geostationary orbit, the satellite 202, 204 may be a low earth orbit (LEO) satellite.

Either or both satellite 202, 204 can comprise a spacecraft and one or more payloads (e.g., the communication payload, an imaging payload, etc.). The satellite 202, 204 may also include a command and data handling system and multiple power sources, such as batteries, solar panels, and one or more propulsion systems, for operating the spacecraft and the payload. The command and data handling system can be used, e.g., to control aspects of a payload and/or a propulsion system but is not limited thereto.

In some embodiments the optical link could also be a satellite to a terrestrial object such as an aircraft or a ground station. Each satellite 202, 204 can communicate with other satellites (e.g., each other or other satellites not shown in FIG. 2) over respective inter-satellite link (ISL) beams 210, 212. For example, the satellite 202 can send data to the satellite 204 over the ISL beam 210 and can receive data from the satellite 204 over the ISL beam 212. Links 210, 212 can also be to other satellites not shown in FIG. 2, e.g., in a relay or mesh arrangement. ISL can use optical signals to communicate between the satellites 202, 204 similar to those described above with reference to FIG. 1.

Coherent receiver detection is performed by “mixing” a local oscillator (LO) laser with the incoming received signal. The LO laser in most receiver architectures is substantially the same frequency or wavelength as that used by the transmitter. Compared to radio frequency (RF) systems of similar architecture in which carrier frequencies and LO sources are referenced off an accurate clock source, laser sources by contrast are much less accurate to control. The laser wavelength is normally controlled by thermally tuning resonant optical circuits. The frequency accuracy of such lasers over the operational lifetime of a device is usually in the order of ±1.5 GHz. This error is not known in advance and is therefore unpredictable and provides a motivation for methods according to aspects that utilize an architecture for improving and enhancing common mode rejection ratio (CMRR) techniques. Common mode refers to a state in amplifiers or other differential circuits in which, when both legs of the amplifier are exercised with the same input stimulus, the amplifier should become common mode and be rejected. However, if there is a mismatch on the differential signal input stimulus to the amplifier a conversion to a differential interference mode will be output from the amplifier creating degradation in the SINR (signal to interference plus noise ratio). Accordingly, rejection of common mode interference is desired.

Optical coherent reception makes use of the rejection of common mode signals such as the intensity demodulation of the received carrier, the LO Laser RIN (Relative Intensity Noise), or broadband interference such as solar background radiation in FSO in the differential photodiodes. Differential imbalance degrades achievable CMRR.

To address these and other concerns, methods and apparatuses as described below can correct for differential imbalance in the receive chain. Methods and algorithms of various aspects can minimize the impact of interference on the wanted receive signal through maximizing the CMRR of the receiver.

Previous apparatuses and methods for reducing interference relied on differential photodiodes, trans-impedance amplifiers (TIAs) and ADCs, but the common mode rejection specifications for precision circuits became increasingly complex. For example, precision circuit design approaches could become increasingly difficult due to variations in manufacturing and fabrication processes, leading to waste and increased costs. Furthermore, devices may be required to operate over a wide wavelength range of receive inputs signals or over a wide temperature or power supply range all which contribute to variations in performance. Precision performance may be achievable for a single wavelength or in a narrow temperature range, but few applications are restricted in this manner.

In contrast, methods according to aspects of the disclosure allow for in-field calibration of CMRR allowing for adjustment due to environmental conditions, aging or receive wavelength. Aspects can be included in FSO applications as part of an optical ISL as shown in FIG. 2, but aspects can also be included in optical fiber channels.

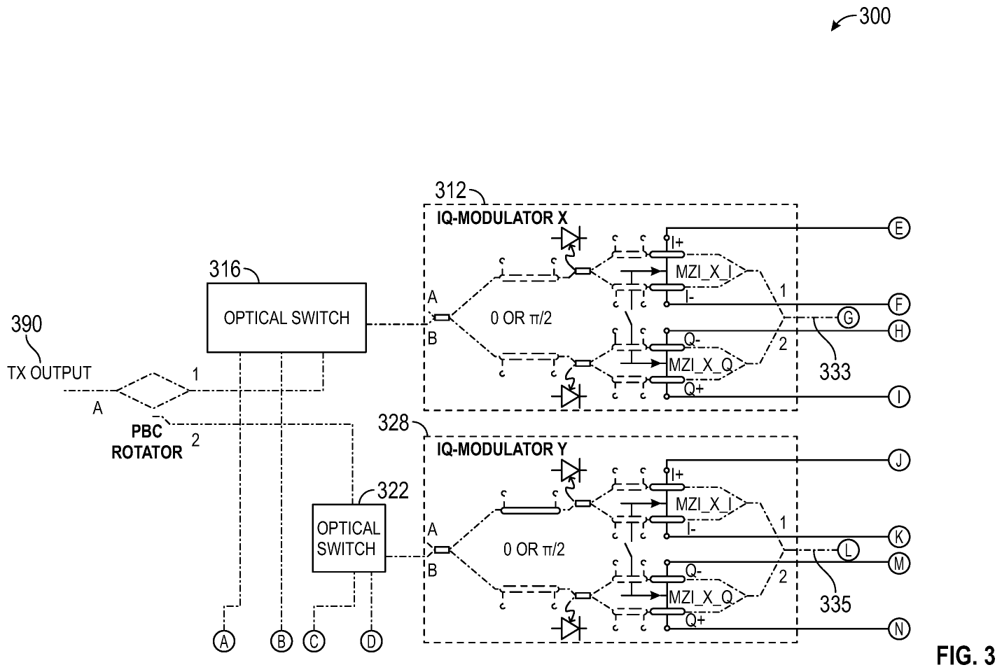

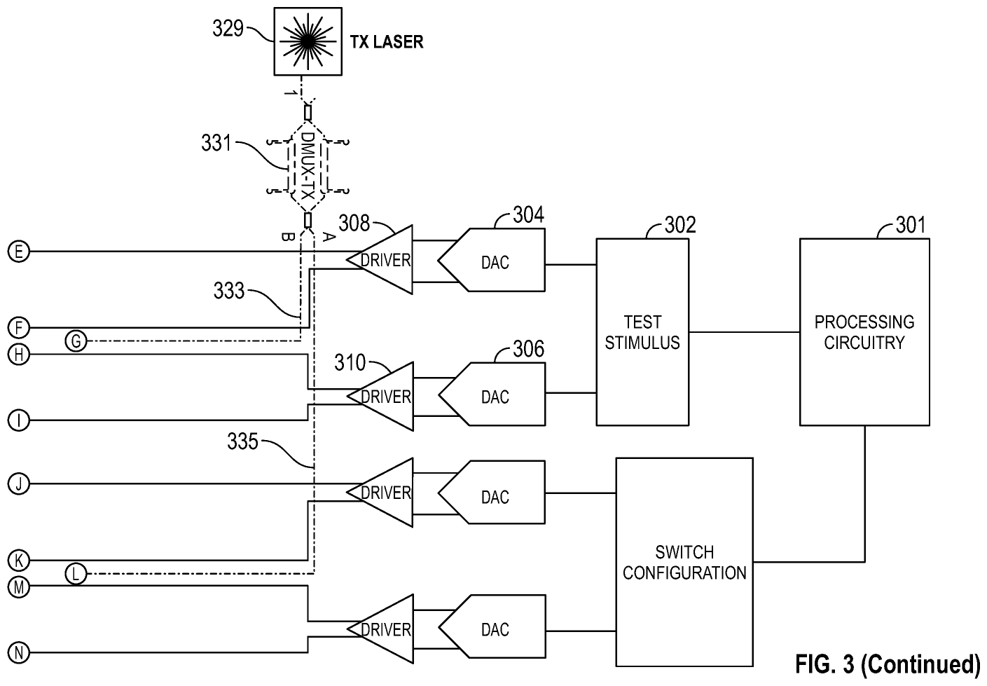

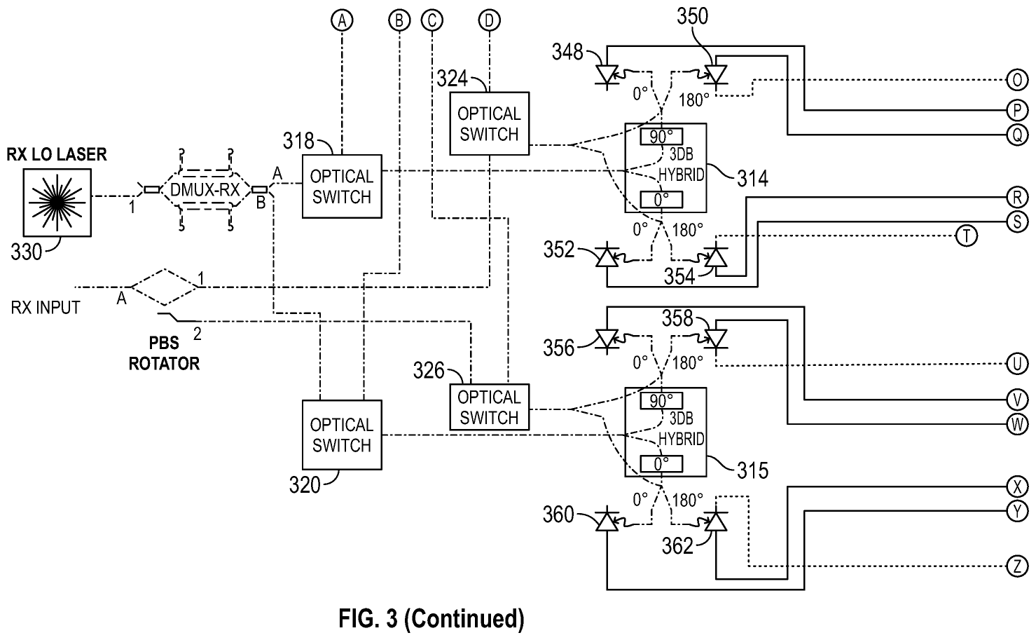

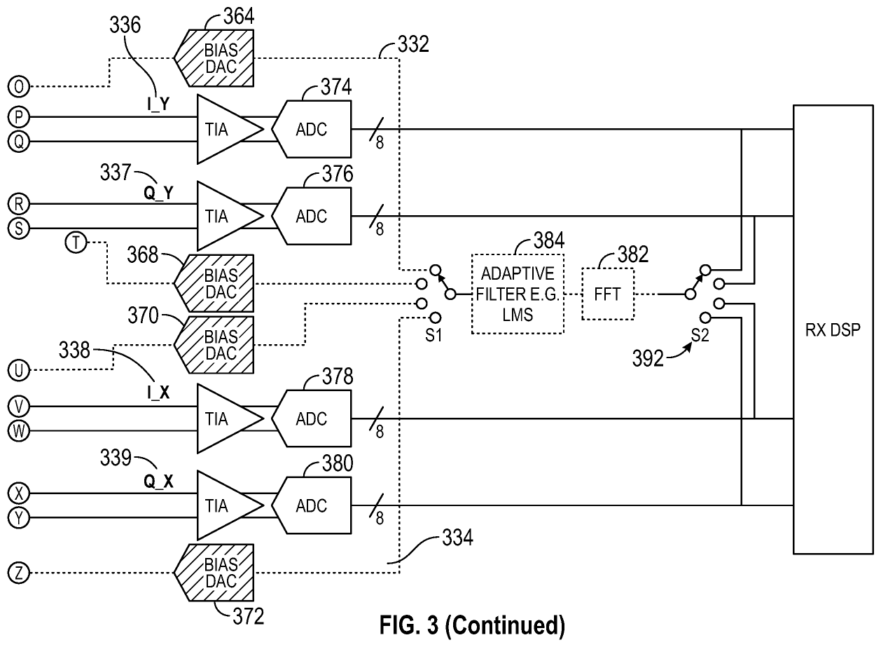

FIG. 3 illustrates a schematic diagram of an apparatus 300 in which methods according to aspects can be implemented. Methods according to aspects provide a calibration algorithm that is invoked by generating a switched input stimulus to a receiver (RX) as shown in FIG. 3.

Referring to FIG. 3, a laser source 329, whose primary purpose in some embodiments is for use as a transmit laser source is input to a power splitter or power divider 331, the power divider is characterized as function that splits the power in the laser signal into two separate photonic signal in separate waveguides 333, 335. These two separate output signals 333 and 335 are input into two respective modulator circuits 312, 328 such as Mach-Zehnder Modulators or micro-ring resonators.

Referring still to FIG. 3, a test stimulus 302 can include an amplitude modulated (AM) signal generated from a first in-phase/quadrature (IQ) digital-to-analog (DAC) pair 304, 306 input to a driver circuit/s 308, 310 and a modulator block 312, wherein the modulator block 312 can comprise, e.g., a Mach-Zehnder Modulator (MZM). The modulated output signal of modulator block 312 is switched into at least one 3 dB hybrid coupler 314, 315 through optical switches 316, 318, 320, 322, 324, 326.

A second IQ modulator 328 is also provided which can be used as static switch used to couple the transmit laser signal which is further switched in through optical switches 316, 318, 320, 322, 324, 326 which can replace the LO signal of the laser. However, a local oscillator (LO) 329 (which also serves as a transmit laser) can be switched in in the place of an independent RX LO laser 330. The LO 329 for the purposes of some calibration embodiments can be switched through a second modulator 328 (e.g., a second MZM) used in this example embodiment as a repurpose of the modulator of the orthogonal polarization on the transmit path. In at least these aspects, the nominal local receive oscillator 330 is removed (e.g., by being switched off) and instead the transmit laser 329 is brought into the receive LO path. This helps avoid the errors and concerns mentioned above, wherein the optical lasers 329, 330 have an unknown and unpredictable error between them, thereby preventing errors during down-conversion (e.g., at ADC circuitry 332, 334, 336, 338). In aspects, by using the transmit laser 329 to generate the input stimulus and using the transmit laser 329 as the LO stimulus, the down-converted signal should be equal in frequency to the test stimulus that was input to the DACs 304, 306. This can minimize complexity in algorithm support as described later herein.

Furthermore, if there are frequency fluctuations on the TX laser 329, then when the IQ down-converted signals are examined, the phase noise becomes common mode because the noise is the same on the LO as on the modulated path and the noise cancels out as will be described later herein.

Each polarization of a dual-polarization receiver comprises a 3 dB hybrid coupler and a differential coupler prior to a pair of differentially configured photodiodes. Aspects of the present disclosure can also be applied to coherent receivers in which a single polarization is used. Referring to FIG. 3, therefore, dual-polarized receivers 332, 334 are provided so that signals 336, 337 with any field on the Y plane and signals 338, 339 on the orthogonal X plane can be received. The 3 dB hybrid couplers 314, 315 can transform the LO laser signal into two components I and Q which is characterized by the signal on the output of the quadrature (Q) path being substantially 90° out of phase to the in-phase (I) path and substantially equal in power. The optical received signal can be split equally and added in phase to each of the I and Q path's 3 dB Hybrid outputs. A coupler then generates an optical differential signal comprising the LO and the receiver input signal. The differential signal is characterized by two individual signals each being of substantially equal magnitude but substantially 180° out of phase with respect to the other.

Each of the differential legs of the optical signal is coupled to a pair of photodiodes 348, 350, 352, 354, 356, 358, 360, 362. The photodiodes 348, 350, 352, 354, 356, 358, 360, 362 convert the incident optical signal into a current proportional to the optical power in the signal. The photodiodes 348, 350, 352, 354, 356, 358, 360, 362 also produce a desired difference product of the LO laser frequency minus input signal frequency. Differential photodiode circuits are used so as the unwanted the common mode signal which acts as an interferer can be suppressed. The suppression of the interference signals is dominated by the common mode rejection of the receiver circuits 332, 334.

The responsivity of the photodiodes 348, 350, 352, 354, 356, 358, 360, 362 (expressed in amps per watt) can be changed through the adjustment of the reverse bias voltage applied. If the photodiodes 348, 350, 352, 354, 356, 358, 360, 362 are not sufficiently matched or if the transmission waveguide into the respective photodiodes are not matched, the outputs are not matched on the inputs 336, 337 (or on inputs 338, 339). Accordingly, bias DACs 364, 368, 370, 372 can be provided to improve matching of signals by creating tune voltages (or reverse bias voltage) on at least one of the photodiodes 348, 350, 352, 354, 356, 358, 360, 362. Tuning according to aspects can help provide for equal or substantially equal responsivity on the photodiodes 348, 350, 352, 354, 356, 358, 360, 362.

The current in each of the photodiodes 348, 350, 352, 354, 356, 358, 360, 362 can be expressed according to:

$${I}_{1} ( t ) = \frac{{R}_{1}}{4} \{ {P}_{s} ( t ) + {P}_{inf} ( t ) + {P}_{LO} ( t ) + 2 \sqrt{{P}_{s} ( t ) {P}_{LO} ( t )} \cdot sin ( ( {ω}_{s} - {ω}_{LO} ) \cdot t ) \} \qquad ( 1 )$$

$${I}_{2} ( t ) = \frac{{R}_{2}}{4} \{ {P}_{s} ( t ) + {P}_{inf} ( t ) + {P}_{LO} ( t ) - 2 \sqrt{{P}_{s} ( t ) {P}_{LO} ( t )} \cdot sin ( ( {ω}_{s} - {ω}_{LO} ) \cdot t ) \} \qquad ( 2 )$$

An ideal differential signal AI (t) (which expresses Equation (1) minus Equation (2)) is described by:

$$Δ I ( ι ) = {I}_{1} ( ι ) - {I}_{2} ( ι ) = \frac{{R}_{1} + {R}_{2}}{2} ( \sqrt{{P}_{s} ( l ) {P}_{L O} ( ι )} \cdot sin ( ( {ω}_{s} - {ω}_{L O} ) \cdot ι ) \qquad ( 3 )$$

where R₁ and R₂ is the respective responsivity of each of the photodiodes 348, 350, 352, 354, 356, 358, 360, 362 in the differential structures. Pₛ(t) is the time variant signal power incident on each of the photodiodes. P_{inf}(t) is any broad band time-varying interference power that may exist on the channel not falling within the channel spectrum occupancy (e.g., the sun, beacons, or other signals that can swamp out the receiver described herein according to aspects). P_{LO}(t) is the LO power including residual intensity noise (RIN). ωₛ and ω_{LO} are the respective instantaneous frequencies of the input test stimulus (e.g., optical signal) 302 and the LO laser 329 respectively expressed in radians per second.

Equation (3) is an ideal differential that is approached or controlled for by algorithms herein. For example, the algorithm tunes so that R₁ and R₂ are preferably equal, and algorithms attempt to tune the photodiodes 348, 350, 352, 354, 356, 358, 360, 362 to achieve this. If, for example there was a mismatch on the differential power divider ratios or a mismatch on the responsivity of the photodiodes 348, 350, 352, 354, 356, 358, 360, 362 then the differential power would not be at the same magnitude as if perfectly balanced but most importantly the terms defined in Equation (3) would now also include uncancelled terms of Pₛ(t), P_{inf}(t) and P_{LO}(t) adding to the wanted signal degrading performance of the receiver.

Referring again to FIG. 3, the receiver circuitry takes feedbacks of the ADCs 374, 376, 378, 380, performing Fast-Fourier Transform (FFT) 382 of the feedback signals, and providing the ADCs 374, 376, 378, 380 to an adaptive filter 384. The adaptive filter 384 can comprise algorithmic logic circuitry that can execute one or more of a LMS algorithm, a Kalman filter, or a minimum mean-squared error (MMSE) algorithm.

The calibration algorithm proposed in example aspects and described herein replaces both the LO and optical input signals with signals derived from the TX path (e.g., the path described above using laser 329). Because circuits already used for the transmission are used to calibrate the receive path, no additional circuits are needed to implement calibration algorithms according to aspects. Replacing the LO path with an unmodulated transmit laser fixes a number of problems including issues described earlier herein in which lasers could have frequency errors that could otherwise be unknown, unpredictable, and accordingly not trivial to mitigate. Further, laser errors could have time, environment, wavelength, or other dependencies that could be difficult to predict or adjust for. Feedback of the LO from a transmission signal allows for phase noise to cancel, and furthermore when the FFT is performed the frequency error of each individual laser does not contribute to which FFT bin selection is used to measure the power of the signal and harmonics. This can reduce the number of bins used for FFT 382, further reducing complexity and saving on power and resources to compute the inputs to the LMS calculations as well as algorithm convergence time.

The FFT 382 can be implemented with dedicated DSP hardware or alternatively can be executed in a processor compute core using stored capture data for each iteration of the LMS 384. Likewise, the LMS 384 can be implemented in dedicated hardware or as part of a software program in a processor core.

In some aspects, the input stimulus 302 from the TX path coupling comprises a substantially 100% amplitude tonal modulated carrier. A 100% AM modulated signal is characterized by suppression of the carrier and the power being primarily contained in the tonal modulation frequency offset from the carrier center frequency. This can be generated from a LUT (look up table) or can be a synthesized source on the DSP feeding the respective DACs 304, 306. The input stimulus 302 spectral profile suppresses the carrier frequency, and the modulated tonal signal is present only in the down converted signal when the TX laser is used for the LO in the down-conversion. The LMS algorithm 384 can leverages this aspect and solves for a ratio of the total modulated signal and the second harmonic of the modulated signal. When the photodiodes 348, 350, 352, 354, 356, 358, 360, 362 are balanced, second harmonics can be maximally suppressed. If the differential balance was perfect the 2^{nd} harmonic would be maximally suppressed.

The LMS engine 384 output can be fed back to bias DACs 364, 368, 370, 372 in some aspects. Changing the bias of the photodiode 348, 350, 352, 354, 356, 358, 360, 362 causes a resultant change in the photodiode 348, 350, 352, 354, 356, 358, 360, 362 responsivity and in doing so the photodiode 348, 350, 352, 354, 356, 358, 360, 362 responsivities can be substantially matched. This would mean that R₁ and R₂ of Equation (1) and Equation (2) would be tuned to substantially output the same current for the same input optical signal power.

In some aspects, the feedback point to the receiver is before any splitting or 3 dB Hybrid coupling of signals in the photonic domain processing. This means that any imbalance in the generation of the differential signals in the optical domain can be offset by the tuning of the photodiodes 348, 350, 352, 354, 356, 358, 360, 362.

In some embodiments the TIA differential adjustments (inputs to the ADCs 374, 376, 378, 380) can be used as alternate to tuning of potential divider (PD) bias as could the divider ratio generation in the photonic IC to generate the differential signals as described herein.

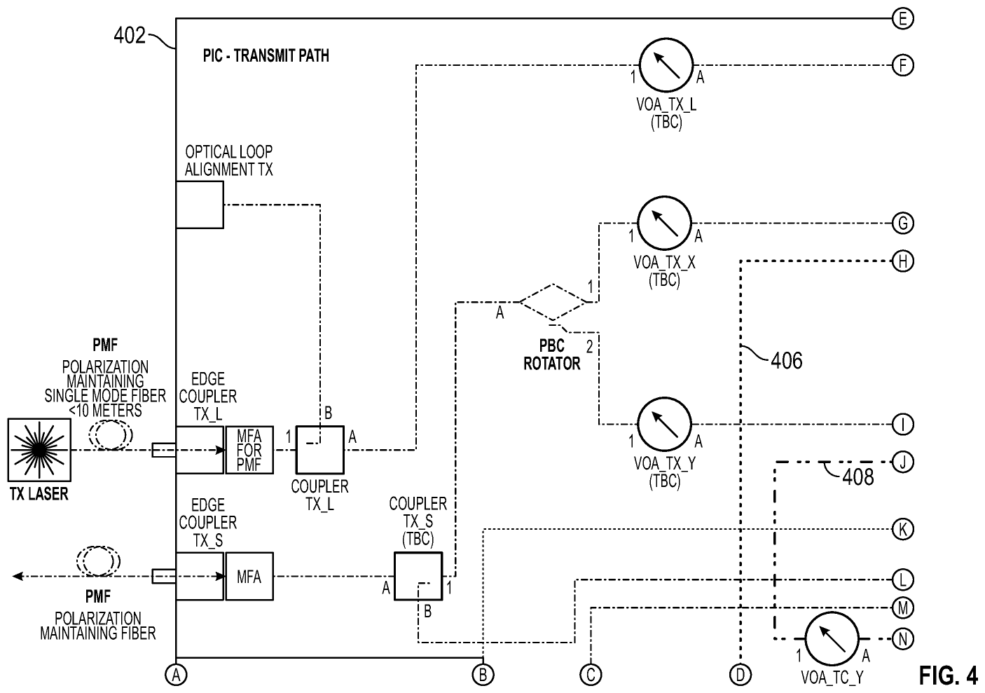

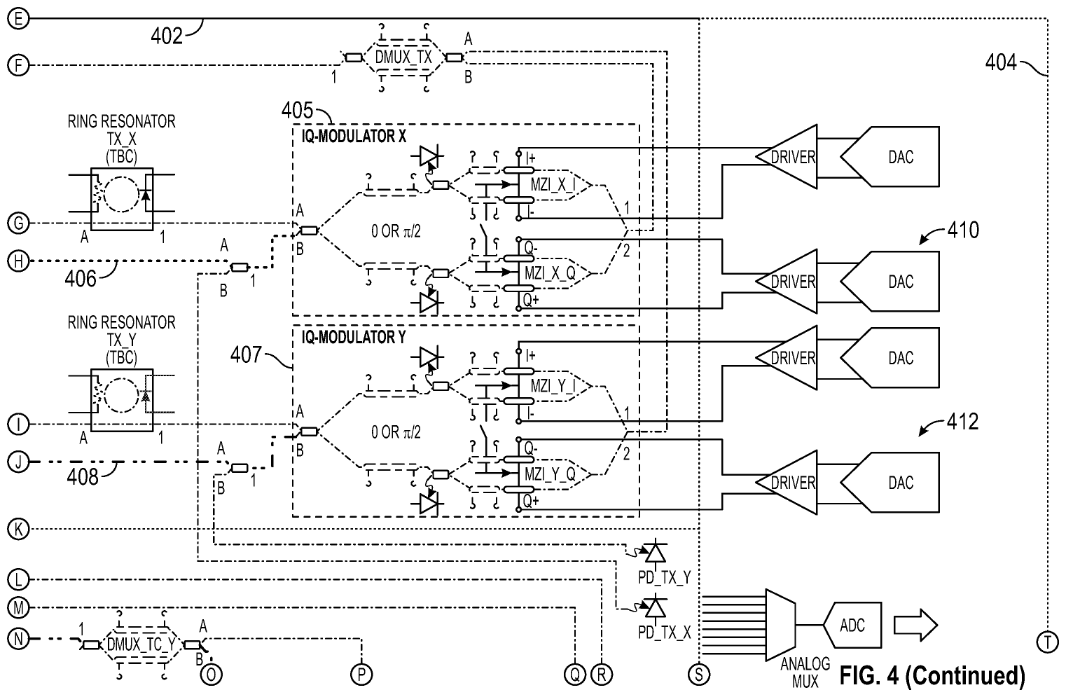

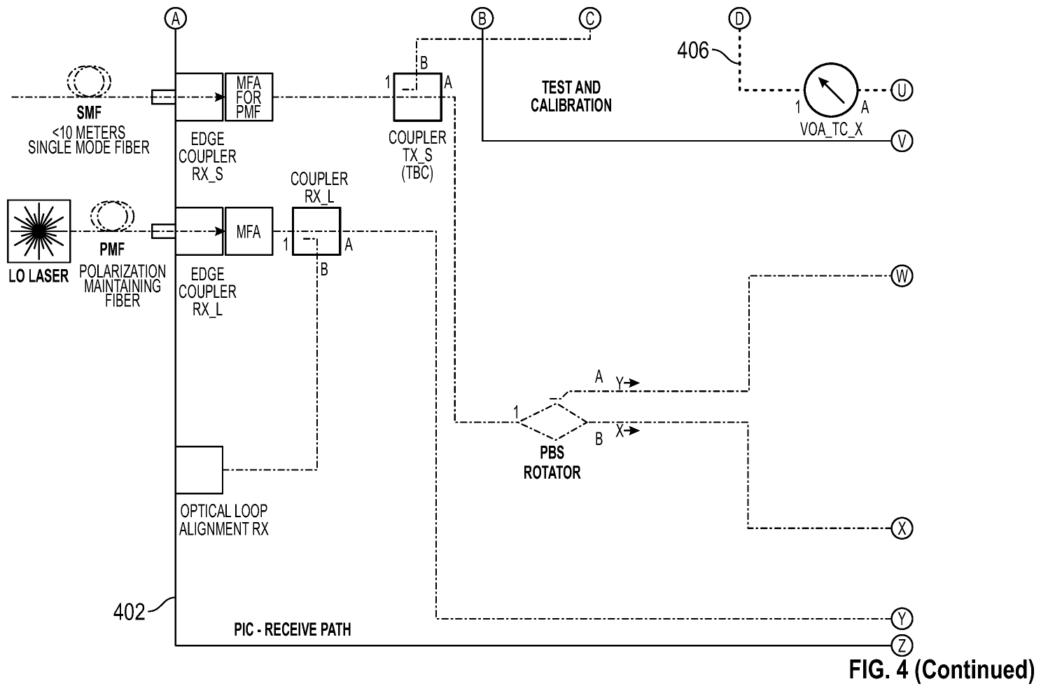

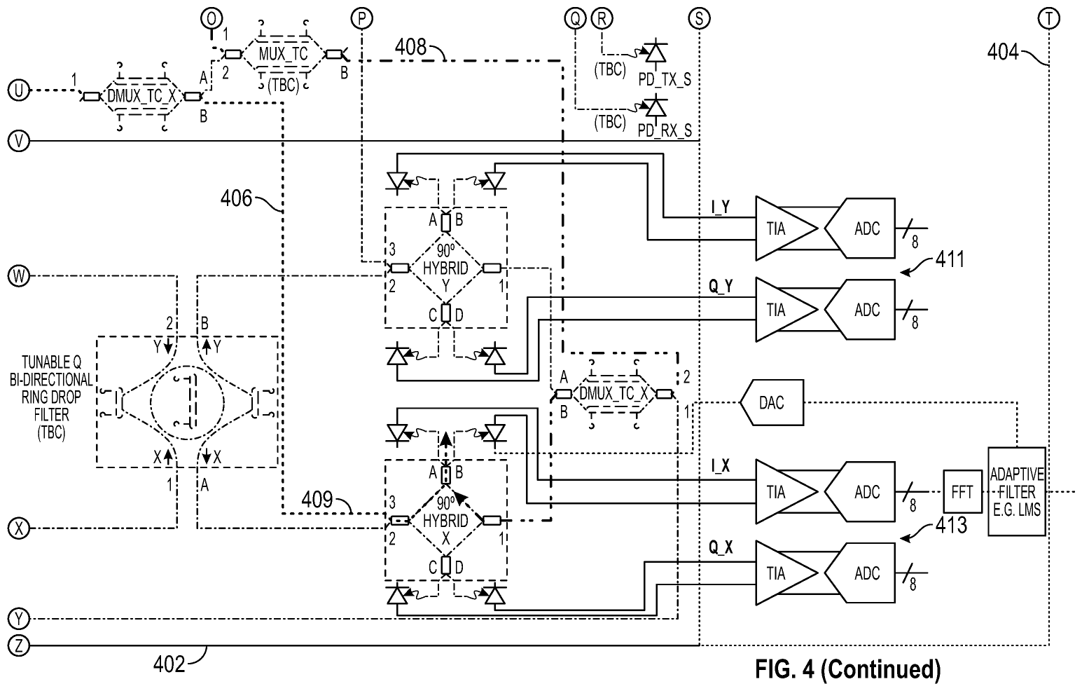

FIG. 4 illustrates feedback paths in the context of photonic sections of a coherent transceiver in accordance with some aspects. As seen in FIG. 4, that some portions 402, 404 can be implemented on different integrated circuits of a platform. For example, in some aspects photonics 402 and electronic circuits 404 can be on different integrated circuits. Test and calibration can also be provided within electronic circuits 404.

In alternate embodiments not shown, dedicated calibration circuits functionally equivalent to that shown herein could be separately instantiated. Advantageously, this invention embodiment allows reuse of the transmit path for calibration of the receive path. Once the calibration is completed the modulator paths and the receive paths can revert to mission mode whereby the transmit generates signals that combined in a polarization beam combiner (PBC) for transmission over an optical fiber or for fiber connection to a free-space optical telescope module (not shown). FIG. 4 shows the circuit schematic of the dual-polarized transceiver in its entirety with connections to fiber for both the laser sources and the respective receive and transmit fibers. Path 406 illustrates a first transmit output path, from optical modulator 405, and an output of one of the optical modulators 405, 407 being coupled to a 90 degree coupler input port 409 of optical receiver 411 or 413. Path 408 illustrates a second MZM modulator output path.

DAC 410 and DAC 412 that in some currently-available systems can convert I and Q versions of the respective dual polarized signals from digital representations thereof to analog equivalents. In systems according to some aspects, DAC 410 and DAC 412 can be used in calibration algorithms in a repurposed manner to convert the signal stored in the Look-up-table 302 to analog equivalents which then are used to modulate the optical signal through the MZMs. The look up table signal based signal is a digital domain signal and cannot be used by the modulator directly without conversion to an analog signal.

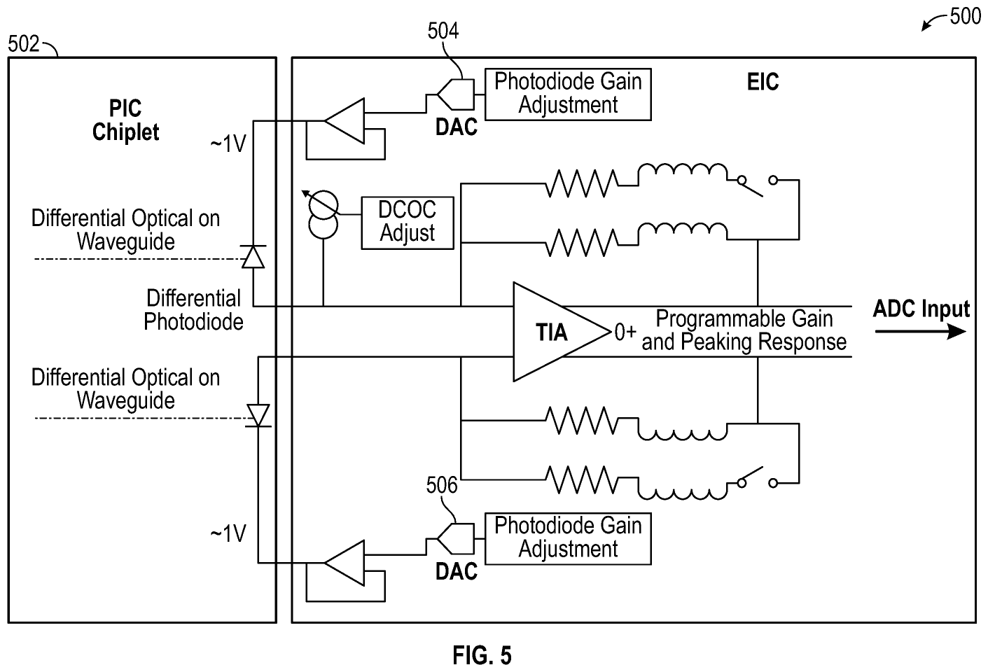

FIG. 5 illustrates DAC bias control 500 according to some aspects. As seen in FIG. 5, a photonics chiplet 502 provides input for photodiode bias control. Bias voltage changes can change the responsivity gain of the photodiode. Photodiode responsivity gain can be adjusted by biasing DACs 504, 506 that were described earlier herein, with respect to photodiodes 348, 350, 352, 354, 356, 358, 360, 362 (FIG. 3) The digital input word to the DACs 504, 506 can be used to change the voltage output thereby allowing for an adjustment on the reverse bias of the photodiodes thereby effecting their responsivity. The DAC output constitutes a variable voltage source for the embodiments described herein for controlling the voltage bias on a photodiode.

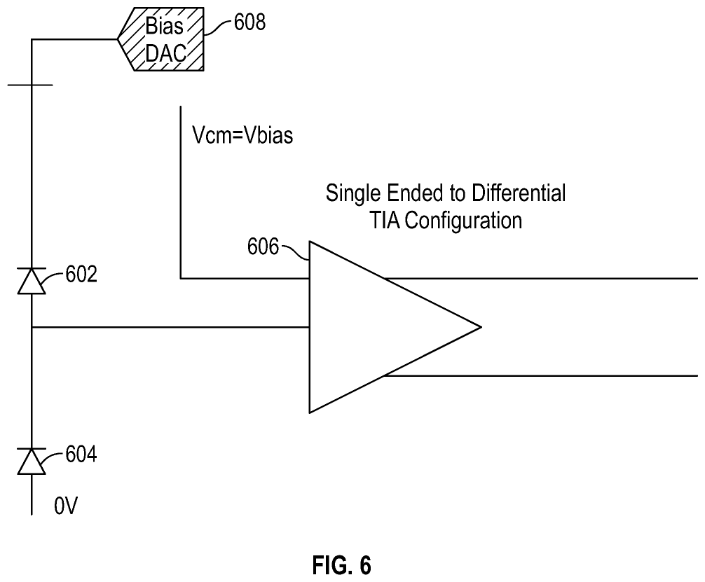

FIG. 6 illustrates DAC bias control according to another aspect. Responsivity of a photodiode 602 is tuned with respect to another photodiode 604 but instead of having a differential input into a TIA 606, a single-ended input is put into the TIA 606. Bias on the DAC 608 is tuned to equalize the responsivity of one of the photodiodes 602 relative to the other photodiode 604.

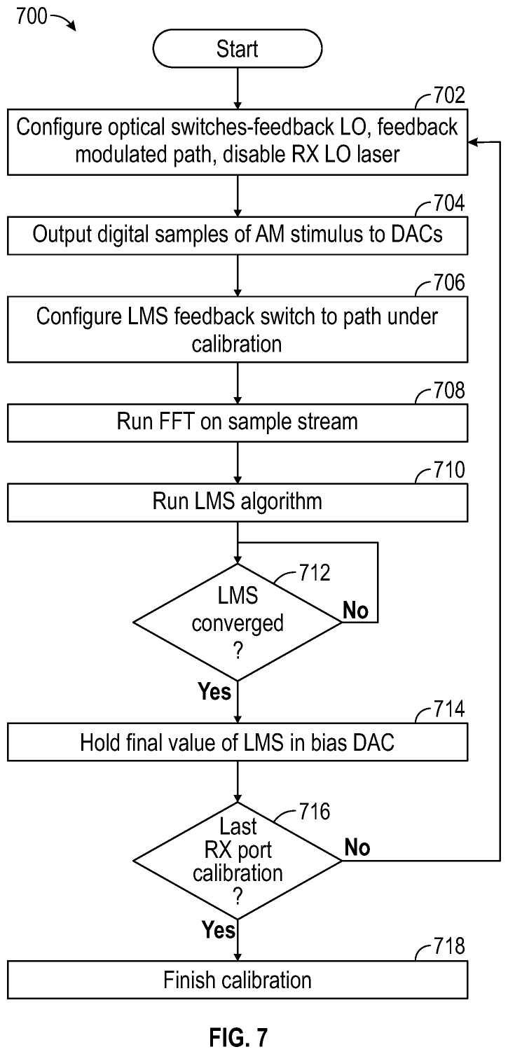

FIG. 7 illustrates a calibration method 700 according to some aspects. Reference is made to components of FIG. 3 when describing operations of method 700. Calibration method 700 can be controlled by processing circuitry 301 implemented in hardware, software, or any combination thereof.

At operation 702, optical switches 316, 318, 320, 322, 324, 326 are configured. During regular operation of the circuitry in FIG. 3, DACs 306 are transmitting data coming out through TX fiber output 390. During operation 702 however, optical switches 316, 318, 320, 322, 324, 326 are switched from transmission mode so that the optical switches 316, 318, 320, 322, 324, 326 instead move signals from the outputs of the modulators 312, 328 into the receive path. In some examples, if only the Y path is to be calibrated, only a subset of switches (e.g., switches 316, 318, 320) will move signals form outputs of the modulators into the receive path. Similarly, if only the X path is to be calibrated, only a subset of switches (e.g., switches 322, 324, 326) will move signals form outputs of the modulators into the receive path. Accordingly, the calibration algorithm configures which optical switches 316, 318, 320, 322, 324, 326 are configured to provide signals from the transmit laser 329 into the receive path. the transmit laser. Finally, receive LO laser 330 is muted as an input the receiver. The switches 392 can take signals from ADC outputs and switch them back into the FFT 382 then back into the LMS 384 to control bias DACs 364, 368, 370, 372 to tune photodiodes. The FFT can comprise hardware or software and the FFT and LMS can be implemented together in software.

At operation 704, the digital samples are output from the stimulus 302. The stimulus 302 outputs signals to DACs 304, 306. The stimulus 302 can be from a signal generator, from LUTs, etc. as described above.

At operation 706, the feedback from LMS 384 is configured. In the digital domain, the switches 392 are controlled to provide feedback from ADCs 374, 376, 378, 380 and the output of the LMS 384 are configured to control different bias DACs 364, 368, 370, 372. For example, the switches 392 are configured. At operation 708, the FFT is run on a sample stream output from the ADC selected through switch 392, and at operation 710 the LMS is run. The LMS looks for a convergence (e.g., a local minimum) at block 712. If a local minimum is found, this value is held in the bias DACs 364, 368, 370, 372 at operation 714, otherwise calibration resumes at operation 702. Convergence can be determined based on any performance criteria such as a convergence time or determination of the error signal on the feedback with the expected level of signal to harmonic ratio. The LMS output cam effect the DAC setting and in doing so cause a change in the responsivity of for example photodiode 348.

The calibration can loop again to another receive port calibration and once completed can exit the calibration routine. Therefore, the method 700 can include operation 716 for determining whether to terminate or repeat the configuring and adapting operations based on whether all receive paths have been configured. At block 718, calibration has been determined to be completed according to the determination at operation 716.

Algorithmic logic circuitry for the embodiments described herein is a circuit or combination of circuits to perform the computational execution of the algorithms used to determine the optimum bias setting on the photodiodes. This processing includes but is not limited to the adaptive filter for example the LMS engine or other adaptive filter alternative implemented in dedicated logic or executed with a software framework in microprocessor core.

### ADDITIONAL DESCRIPTION AND EXAMPLES

These several embodiments and examples can be combined using any permutation or combination. The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

In Example 1 an apparatus comprises: optical circuitry configured to provide an optical signal source to be divided into a plurality of paths, a first path of the plurality of paths being input into an optical modulator, an output of the optical modulator being coupled to an input port of a first optical receiver, a second path of the plurality of paths being provided to a local oscillator port of the first optical receiver; the first optical receiver comprising at least one coupler, an output of the coupler configured to provide input to at least one differentially configured pair of photodiodes, the photodiodes currents output being operably coupled to an analog to digital converter (ADC); and feedback circuitry configured to provide outputs of the ADC to an algorithmic logic circuitry, the algorithmic logic circuitry being coupled to a variable voltage source.

In Example 2, the subject matter of Example 1 can optionally include wherein at least one photodiode of the photodiodes is coupled to at least one variable voltage source to control the responsivity of the corresponding photodiode.

In Example 3, the subject matter of Example 2 can optionally include wherein the algorithmic logic circuitry is configured to implement an adaptive filter algorithm.

In Example 4, the subject matter of Example 3 can optionally include wherein the adaptive filter algorithm comprises one of a least means squares (LMS) algorithm, a Kalman algorithm, or a minimum mean-squared error algorithm.

In Example 5, the subject matter of Example 3 can optionally include Fast-Fourier Transform (FFT) circuitry configured to provided transformed outputs of the ADC to the algorithmic logic circuitry.

In Example 6, the subject matter of Example 2 can optionally include wherein the optical receiver comprises a dual-polarization receiver.

In Example 7, the subject matter of Example 6 can optionally include, wherein a hybrid coupler is configured to transform a local oscillator (LO) laser signal into an in-phase component and a quadrature component and wherein a hybrid coupler output is configured to generate an optical differential signal comprising at least the LO laser signal or a receiver input signal.

In Example 8, the subject matter of Example 7 can optionally include wherein the photodiodes are configured to generate a difference product of a frequency of the LO laser frequency minus input signal frequency.

In Example 9, the subject matter of Example 8 can optionally include bias circuitry to generate tuning voltages as inputs for the photodiodes.

In Example 10, the subject matter of any of Examples 1-9 can optionally include at least one optical switch, the at least one optical switch configured to switch signals from a transmission path of the apparatus to a receive path of the apparatus.

In Example 11, the subject matter of any of Examples 1-10 can optionally include wherein the apparatus is included in least one of a channel media, a fiber system, a terrestrial free-space optics (FSO) system, a satellite-to-satellite FSO system or a combination thereof.

Example 12 is a method for calibrating a common mode rejection ratio of an optical transceiver, the method comprising: configuring optical switches to enable routing at least one output signal of modulator circuitry operably coupled to a first receive path of a coherent optical transceiver; configuring the input to at least one modulator to generate at least one first stimulus signal; configuring a path from the first receiver analog-to-digital converter to an adaptive algorithm circuitry; adapting at least one bias setting of a photodiode associated with the first receiver in response to at least one first stimulus detected at the first receiver analog-to-digital converter to an adaptive algorithm circuitry; determines an optimum value of a photodiode associated with the first receiver through algorithm convergence; and determining whether to terminate or repeat the configuring and adapting operations based on whether all receive paths have been configured.

In Example 13, the subject matter of Example 12 can optionally include wherein configuring the optical switches comprises configuring a subset of the optical switches to be calibrated and refraining from configuring optical switches that are not to be calibrated.

In Example 14, the subject matter of any of Examples 12-13 can include wherein providing the input stimulus comprises providing inputs from a signal generator.

In Example 15, the subject matter of any of Examples 12-14 can optionally include where the algorithmic convergence solves for a minimization of the second harmonic in response to receiving a substantially one-hundred percent amplitude modulated tonally modulated signal.

In Example 16, the subject matter of any of Examples 12-15 can optionally include wherein the method is applied to at least one of a channel media, a fiber system, a terrestrial free-space optics (FSO) system, a satellite-to-satellite FSO system or a combination thereof.

Example 17 is an integrated circuit configured to perform operations comprising: configuring optical switches to enable routing at least one output signal of modulator circuitry operably coupled to a first receive path of a coherent optical transceiver; configuring the input to at least one modulator to generate at least one first stimulus signal; configuring a path from the first receiver analog-to-digital converter to an adaptive algorithm circuitry; adapting at least one bias setting of a photodiode associated with the first receiver in response to at least one first stimulus detected at the first receiver analog-to-digital converter to an adaptive algorithm circuitry; determines an optimum value of a photodiode associated with the first receiver through algorithm convergence; and determining whether to terminate or repeat the configuring and adapting operations based on whether all receive paths have been configured.

In Example 18, the subject matter of Example 17 can optionally include wherein configuring the optical switches comprises configuring a subset of the optical switches to be calibrated and refraining from configuring optical switches that are not to be calibrated.

In Example 19, the subject matter of any of Examples 17-18 can include wherein providing the input stimulus comprises providing inputs from one of a signal generator and a look up table.

In Example 20, the subject matter of any of Examples 17-19 can optionally include where the algorithmic convergence solves for a minimization of the second harmonic in response to receiving a substantially one-hundred percent amplitude modulated tonally modulated signal.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An apparatus comprising:
optical circuitry configured to provide an optical signal source to be divided into a plurality of paths, a first path of the plurality of paths being input into an optical modulator, an output of the optical modulator being coupled to an input port of a first optical receiver, a second path of the plurality of paths being provided to a local oscillator port of the first optical receiver;
the first optical receiver comprising at least one coupler, an output of the coupler configured to provide input to at least one differentially configured pair of photodiodes, the photodiodes currents output being operably coupled to an analog to digital converter (ADC); and
feedback circuitry configured to provide outputs of the ADC to an algorithmic logic circuitry, the algorithmic logic circuitry being coupled to a variable voltage source.

2. The apparatus of claim 1, wherein at least one photodiode of the photodiodes is coupled to at least one variable voltage source to control the responsivity of the corresponding photodiode.

3. The apparatus of claim 2, wherein the algorithmic logic circuitry is configured to implement an adaptive filter algorithm.

4. The apparatus of claim 3, wherein the adaptive filter algorithm comprises one of a least means squares (LMS) algorithm, a Kalman algorithm, or a minimum mean-squared error algorithm.

5. The apparatus of claim 3, further comprising Fast-Fourier Transform (FFT) circuitry configured to provided transformed outputs of the ADC to the algorithmic logic circuitry.

6. The apparatus of claim 2, wherein the optical receiver comprises a dual-polarization receiver.

7. The apparatus of claim 6, wherein a hybrid coupler is configured to transform a local oscillator (LO) laser signal into an in-phase component and a quadrature component and wherein a hybrid coupler output is configured to generate an optical differential signal comprising at least the LO laser signal or a receiver input signal.

8. The apparatus of claim 7, wherein the photodiodes are configured to generate a difference product of a frequency of the LO laser frequency minus input signal frequency.

9. The apparatus of claim 8, further comprising bias circuitry to generate tuning voltages as inputs for the photodiodes.

10. The apparatus of claim 1, further comprising at least one optical switch, the at least one optical switch configured to switch signals from a transmission path of the apparatus to a receive path of the apparatus.

11. The apparatus of claim 1, wherein the apparatus is included in least one of a channel media, a fiber system, a terrestrial free-space optics (FSO) system, a satellite-to-satellite FSO system or a combination thereof.

12. A method for calibrating a common mode rejection ratio of an optical transceiver, the method comprising:
configuring optical switches to enable routing at least one output signal of modulator circuitry operably coupled to a first receive path of a coherent optical transceiver;
configuring the input to at least one modulator to generate at least one first stimulus signal;
configuring a path from the first receiver analog-to-digital converter to an adaptive algorithm circuitry;
adapting at least one bias setting of a photodiode associated with the first receiver in response to at least one first stimulus detected at the first receiver analog-to-digital converter to an adaptive algorithm circuitry;
determining an optimum value of a photodiode associated with the first receiver through algorithm convergence; and
determining whether to terminate or repeat the configuring and adapting operations based on whether all receive paths have been configured.

13. The method of claim 12, wherein configuring the optical switches comprises configuring a subset of the optical switches to be calibrated and refraining from configuring optical switches that are not to be calibrated.

14. The method of claim 12, wherein providing the input stimulus comprises providing inputs from a signal generator.

15. The method of claim 12, where the algorithmic convergence solves for a minimization of the second harmonic in response to receiving a substantially one-hundred percent amplitude modulated tonally modulated signal.

16. The method of claim 12, wherein the method is applied to at least one of a channel media, a fiber system, a terrestrial free-space optics (FSO) system, a satellite-to-satellite FSO system or a combination thereof.

17. An integrated circuit configured to perform operations comprising:
configuring optical switches to enable routing at least one output signal of modulator circuitry operably coupled to a first receive path of a coherent optical transceiver;
configuring the input to at least one modulator to generate at least one first stimulus signal;
configuring a path from the first receiver analog-to-digital converter to an adaptive algorithm circuitry;
adapting at least one bias setting of a photodiode associated with the first receiver in response to at least one first stimulus detected at the first receiver analog-to-digital converter to an adaptive algorithm circuitry;
determines an optimum value of a photodiode associated with the first receiver through algorithm convergence; and
determining whether to terminate or repeat the configuring and adapting operations based on whether all receive paths have been configured.

18. The integrated circuit of claim 17, wherein configuring the optical switches comprises configuring a subset of the optical switches to be calibrated and refraining from configuring optical switches that are not to be calibrated.

19. The integrated circuit of claim 17, wherein providing the input stimulus comprises providing inputs from one of a signal generator and a look up table.

20. The integrated circuit of claim 17, where the algorithmic convergence solves for a minimization of the second harmonic in response to receiving a substantially one-hundred percent amplitude modulated tonally modulated signal.
